(19) United States
(12) Patent Application Publication
(10) Pub. No.: US 2009/0177697 A1
(43) Pub. Date: Jul. 9, 2009

(54) CORRELATION AND PARALLELISM AWARE MATERIALIZED VIEW RECOMMENDATION FOR HETEROGENEOUS, DISTRIBUTED DATABASE SYSTEMS

(75) Inventors: Dengfeng Gao, San Jose, CA (US); Haifeng Jiang, Sunnyvale, CA (US); Wen-Syan Li, Fremont, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/970,966

(22) Filed: Jan. 8, 2008

(51) Int. Cl. G06F 17/30

(52) U.S. Cl. 707/104.1; 707/E17.032

(57) ABSTRACT

A method is provided for generating a materialized view recommendation for at least one back-end server that is connected to a front-end server in a heterogeneous, distributed database system that comprises parsing a workload of federated queries to generate a plurality of query fragments; invoking a materialized view advisor on each back-end server with the plurality of query fragments to generate a set of candidate materialized views for each of the plurality of query fragments; identifying a first set of subsets corresponding to all nonempty subsets of the set of candidate materialized views for each of the plurality of query fragments; identifying a second set of subsets corresponding to all subsets of the first set of subsets that are sorted according to a dominance relationship based upon a resource time for the at least one back-end server to provide results to the front-end server for each of the first set of subsets; and performing a cost-benefit analysis of each of the second set of subsets to determine a recommended subset of materialized views that minimizes a total resource time for running the workload against the at least one back-end server.

### BACKGROUND OF THE INVENTION

1. Field of the Invention

Exemplary embodiments of the present invention relate database querying, and more particularly to MQT recommendations for distributed databases.

2. Description of Background

A federated database system is a type of meta-database management system (DBMS) that transparently integrates multiple autonomous database systems into a single federated database. Thus, a federated database is the fully integrated, logical composite of all constituent databases in a federated database system. Because the constituent database systems remain autonomous, a federated database system presents a workable alternative to the possibly overwhelming task of merging together several disparate databases.

A wide variety of applications require access to multiple heterogeneous, distributed data sources. Data can be distributed among multiple databases that could be stored in a single computer or multiple computers, which may be geographically decentralized but interconnected by a network. Heterogeneities in databases can arise due to several factors, including differences in structures, semantics of data, the constraints supported, or query language. Through data abstraction, federated database systems can provide a uniform front-end user interface that enables users and clients to store and retrieve data in multiple noncontiguous databases with a single query, even if the constituent databases are heterogeneous. To this end, a federated database system first operates to deconstruct the query into subqueries for submission to the relevant constituent DBMSs, then integrates the resulting sets of the subqueries. Because various database management systems employ different query languages, federated database systems can apply wrappers to the subqueries to translate them into the appropriate query languages. By transparently integrating such diverse data sources, underlying differences in DBMSs, languages, and data models can be hidden, and users can employ a single data model and a single high-level query language for accessing the unified data through a global schema.

For example, many large insurance companies require access to distributed and often heterogeneous databases for business intelligence (BI) applications used to gather, provide access to, and analyze data and information about company operations. Typically, distributed databases are integrated into a centralized data warehouse for the benefit of easy maintenance. By integrating distributed databases, these companies can enhance the insurance underwriting process; enable a single view of the customer; provide greater intelligence and data about individual customer needs for up-selling and cross-selling purposes; improve the ability to capture, track and display performance information for management; and improve the database-intensive clearance process during which databases from multiple branches must be searched. This approach, however, needs to overcome the complexity of data loading and job scheduling, as well as scalability issues.

To support federation of such distributed databases, IBM has developed the WebSphere Information Integrator (WebSphere II), which provides relational access to both relational DBMSs and non-relational sources such as file systems and Web services. The remote data sources are registered within WebSphere II as nicknames and thereafter can be accessed via wrappers. Statistics about the remote data sources are collected and maintained in WebSphere II for later use by the query optimizer for estimating the cost of query plans. From the view of a federation, WebSphere II is a federation server and the remote data sources/databases are remote servers. From the view of a multi-tiered enterprise information system, WebSphere II is a front-end server while the remote data sources/databases are back-end servers, which are accessed by users indirectly through the front-end server. An exemplary architecture of such a distributed data warehouse 10 is provided in FIG. 1a. Data warehouse includes a front-end (or federated) server 12 that receives federated queries. For simplicity, the distributed data warehouse only has two back-end (or remote) servers 14, 16 that store the base tables. In principle, there is no limit on the number of back-end servers in such a system.

BI applications typically require great computation power for performing data intensive processes that aggregate large amounts of data. Therefore, the approach of a fully federated system may not be feasible for data intensive BI applications. To significantly improve the performance of database querying in such applications, a materialized view or Materialized Query Table (MQT), which is an auxiliary table with pre-computed data representing the query result that is cached and may be updated from the original base tables from time to time, can be used. An MQT Advisor (MQTA) is often used to recommend and create MQTs to reduce the query processing cost by replacing parts of queries with existing and appropriately matched MQTs. State-of-the-art MQT advisors that are employed in commercial DBMSs such as the IBM DB2 Design Advisor can be used to recommend MQTs for a stand-alone database.

An exemplary architecture of a stand-alone database 20 is provided in FIG. 1b. Stand-alone database 20 includes a front-end (or federated) server 22 that receives federated queries, and two back-end servers 24, 26 within which base tables and MQTs created and recommended by respective MQTAs 28, 29 are stored. This configuration has two prominent limitations. First, because MQTs are placed on the same server as that in which the base tables are located, this configuration does not apply to a federated system scenario in which MQTs need to be placed on one or more servers other than the server containing the base tables. Second, because the MQTA runs separately for each individual server, the correlation of access to the database servers is not exploited.

To overcome the first limitation described above, a hybrid approach using a Data Placement Advisor (DPA) has been proposed for recommending MQTs for distributed databases. For access of multiple back-end database systems in BI applications, a DPA can be implemented to recommend and place MQTs on the federation server to improve the performance of complex, federated queries. The hybrid approach employing intelligent data placement is more flexible and applicable than centralized or full-federation configurations. The current implementation of this hybrid approach to integrating distributed databases is to aggregate selected data from various remote sources as materialized views and cache the aggregated data at the federation server to improve the performance of complex BI query workloads.

Nevertheless, the caching of MQTs at the front-end server in the current implementation of this hybrid approach will not usually be able to help all the queries in a workload. This is because typically only a subset of the queries utilizes MQTs. Moreover, only a subset of the MQT candidates are recommended by DPA due to the disk space constraint imposed. In any case, there are some queries that must access data at the back-end servers. Furthermore, the data aggregation is performed at the front-end server for creating and refreshing of the MQTs. Because creating and refreshing MQTs are expensive tasks, this approach is suitable only when the federation server is substantially more powerful than the back-end servers and the front-end server is not used as a production system when the data aggregation is performed. Finally, in performing data refreshment, because the MQTs and the base tables used to derive the MQTs are in different servers, MQTs can only be refreshed periodically instead of being refreshed in real time. As a result, this approach not suitable for BI applications in which freshness of MQTs is critical.

### SUMMARY OF THE INVENTION

The shortcomings of the prior art can be overcome and additional advantages can be provided through exemplary embodiments of the present invention that are related to a method for generating a materialized view recommendation for at least one back-end server that is connected to a front-end server in a heterogeneous, distributed database system. The method comprises parsing a workload of federated queries to generate a plurality of query fragments; invoking a materialized view advisor on each back-end server with the plurality of query fragments to generate a set of candidate materialized views for each of the plurality of query fragments; identifying a first set of subsets corresponding to all nonempty subsets of the set of candidate materialized views for each of the plurality of query fragments; identifying a second set of subsets corresponding to all subsets of the first set of subsets that are sorted according to a dominance relationship based upon a resource time for the at least one back-end server to provide results to the front-end server for each of the first set of subsets; and performing a cost-benefit analysis of each of the second set of subsets to determine a recommended subset of materialized views that minimizes a total resource time for running the workload against the at least one back-end server.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that can be implemented to provide MQT recommendation for multiple back-end servers that are connected to a production front-end server that may or may not allow MQTs by taking into consideration the correlation between MQTs as well the parallelism property of multiple back-end distributed systems. Exemplary embodiments of the present invention can be implemented to coordinate the MQT recommendation process for multiple back-end servers and enable the recommendation process to scale well with the number of back-end servers. Exemplary embodiments can be significantly more efficient and effective in providing MQT recommendation than the existing art.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1a is a block diagram illustrating the architecture of an exemplary distributed data warehouse.

FIG. 1b is a block diagram illustrating the architecture of an exemplary stand-alone database.

FIG. 2 is a block diagram illustrating the architecture of an exemplary embodiment of a distributed database in accordance with the present invention.

FIG. 3a is an illustration of a general example of a federated query.

FIG. 3a is an illustration of a general example of a federated query in which the query times for the back-end servers are different.

FIG. 4 is a block diagram illustrating an exemplary embodiment of a distributed system topology and a general operational flow of executing an example federated query within such a system.

FIG. 5 is a block diagram illustrating the system architecture of an exemplary embodiment of a federated MQTA and an operational flow of executing a given federated query therewithin in accordance with the present invention.

FIG. 6 is a block diagram illustrating an exemplary embodiment of a set of federated queries and the MQTs used by the federated queries at back-end servers.

FIG. 7 is a flow diagram illustrating an exemplary embodiment of a process for determining which MQTs are to be placed at the back-end servers in a distributed database system in accordance with the present invention.

FIG. 8a is an illustration of an example of a federated query that uses three MQTs from three back-end servers.

FIG. 8b is an illustration of an example of a federated query that uses four MQTs from three back-end servers.

FIG. 9 is a block diagram illustrating an exemplary hardware configuration or a computer system within which exemplary embodiments of the present invention can be implemented

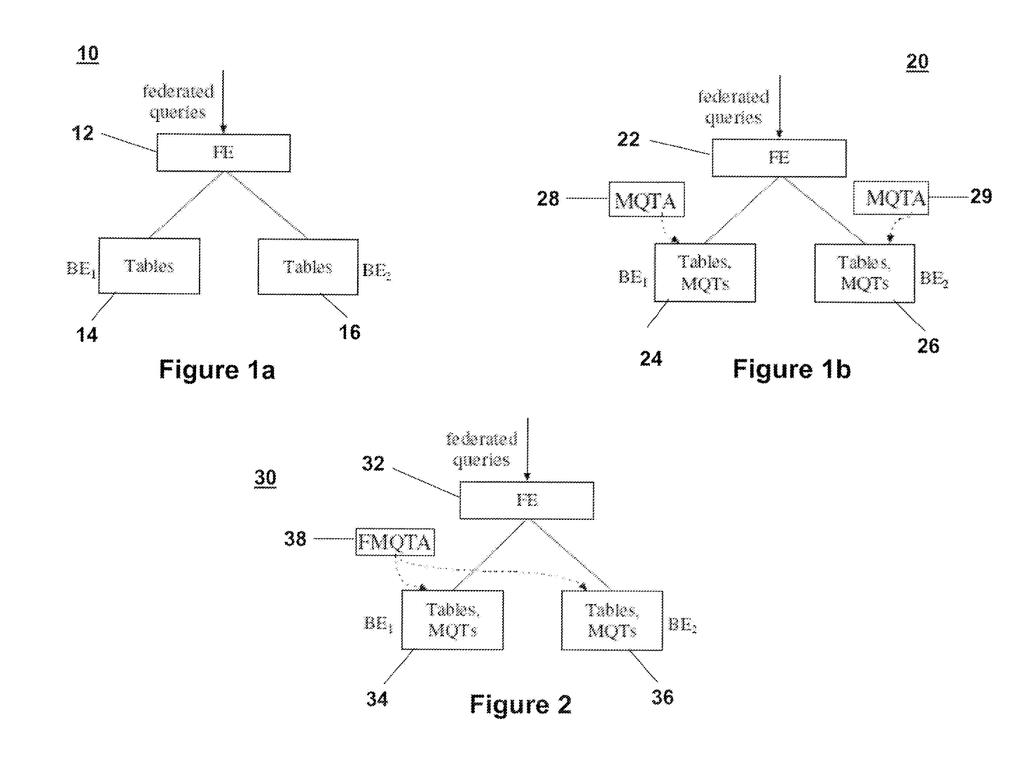

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention.

Exemplary embodiments of the present invention are directed to an implementation within a distributed database system that recommends Materialized Query Tables (MQTs) for back-end servers to improve subqueries by considering correlation between back-end servers. Exemplary embodiments can be implemented to recommend MQTs that are well coordinated among back-end servers and optimized for workload to provide the benefits of load distribution and easy maintenance of aggregated data in conjunction with the current hybrid approach of data placement. Exemplary embodiments can be implemented to exploit the parallelism property provided by simultaneous processing among the back-end servers so as to run nearly linearly with respect to the number of back-end servers without sacrificing its recommendation quality. Exemplary embodiments can be implemented in combination with the approach of data placement by aggregating selected data from various remote sources as materialized views and caching the aggregated data at the front-end federation server to improve the performance of complex query workloads.

Referring now to FIG. 2, an exemplary embodiment of the architecture of a distributed database 30 is provided in accordance with the present invention. Database 30 includes a front-end (or federated) server 32 that receives federated queries, and two back-end servers 34, 36 within which base tables and MQTs are stored. The exemplary embodiment depicted in FIG. 2 implements a federated MQT advisor (FMQTA) 38 for recommending MQTs at the back-end servers.

FMQTA 38 can be implemented to further improve the performance of the federated queries. As an example, assume front-end MQTs can improve the performance of the federated workload by 50 percent, and FMQTA 38 can recommend back-end MQTs that can further improve the performance of the workload by 50 percent. The resulting total improvement would then be 75 percent. Furthermore, in an alternative example, the caching of MQTs at the back-end servers can improve the performance of the federated queries even when front-end MQTs are not present. Nevertheless, recommending MQTs at multiple back-end servers also raises some unique technical challenges that do not appear in recommending front-end MQTs. First, the placing of MQTs on multiple back-end databases calls for intelligent coordination between these back-end servers. Second, scalability becomes more a more prominent issue, and thus, a properly designed algorithm is needed to avoid implementing an exponential approach that may fail even for a small number of back-end servers.

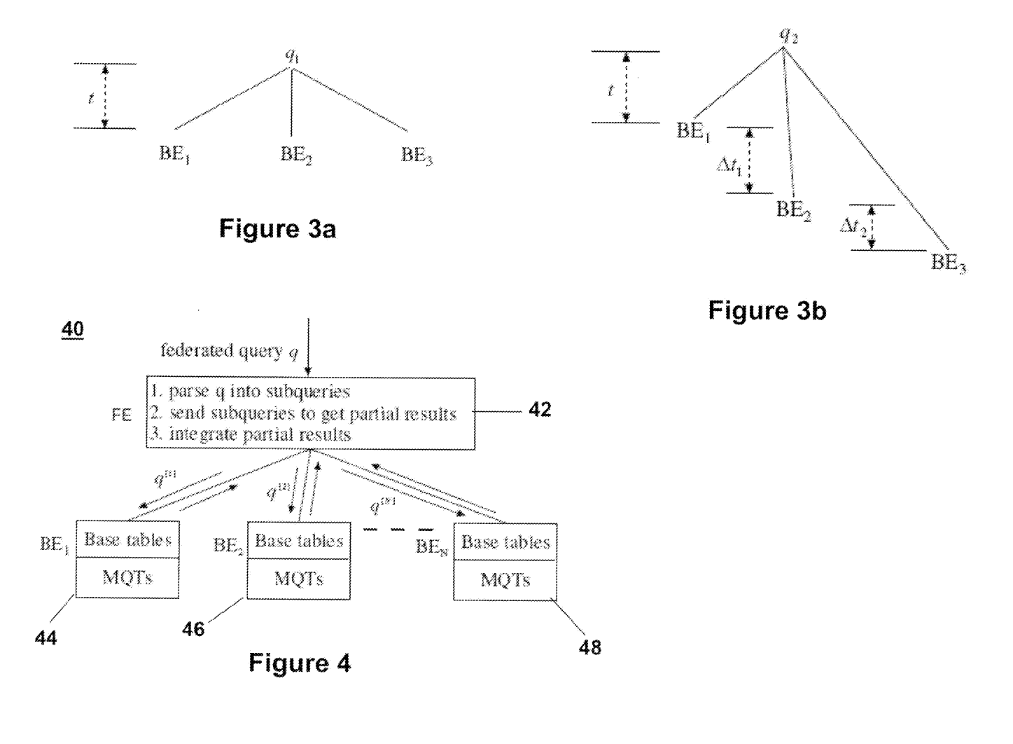

In exemplary embodiments, an FMQTA can be implemented to execute an algorithm that recommends MQTs for all the back-end servers in a coordinated way by using the correlation information about the MQTs (for example, whether MQTs are used by the same federated query) so as to maximize the synergy among the recommended MQTs on different back-end servers. To illustrate the use of such an algorithm, FIG. 3a provides a general example of a federated query. The federated query q1 needs to access data in three back-end servers (BE₁, BE₂ and BE₃) by sending respective subqueries to each of the corresponding back-end servers. The subqueries may contain, for example, cost-intensive join or aggregate operations from BI applications. The vertical distance between q1 and the back-end servers indicates the time to execute the subquery on each back-end server. In this example, the access time is t for each back-end server. To reduce the total resource time for the federated query, the federated MQTA may be used to recommend MQTs on the back-end servers, by materializing the results of subqueries. For the example in FIG. 3a, the federated MQTA takes into consideration the correlation between the back-end servers and recommends MQTs either for all of the three back-end servers or for none of them. To further illustrate the use of such an algorithm, FIG. 3b provides a general example of a federated query in which the query times for the back-end servers are different. For this case, the federated MQTA may be used first to recommend MQTs only for BE₃ to speed up to Δt₂. After that, the federated MQTA may be used to recommend further MQTs for BE₃ and BE₂ to save more overall time (up to an additional Δt₁).

In exemplary embodiments, to avoid the exponential solution, the parallelism property provided by simultaneous processing in multi-back-end systems can be exploited to reduce the complexity of the algorithm. Such an approach can be implemented to not only be effective in MQT recommendation but also scalable and efficient to run.

An exemplary distributed system topology 40 within which exemplary embodiments of the present invention can be implemented and a general operational flow of executing an exemplary federated query within such a system is illustrated in FIG. 4. The exemplary arrangement of FIG. 4 assumes that a query fragment submitted to one back-end server is independent from query fragments submitted to the other back-end servers. In system topology 40, a thin front-end server 42 (such as, for example, one running WebSphere II) is supported by N back-end servers 44₁, 44₂, . . . 44_{N} that contain operational business data. By “thin”, it is meant that front-end server 42 does not cache any base-table data from back-end servers 44. Nicknames for the tables in back-end servers 44 are created at front-end server 42, and database statistics and appropriate information of the back-end servers are copied to the front-end server for cost estimation and query routing. Each back-end server may contain not only the base tables that contain operational data, but also MQTs to speed up the processing of queries routed from front-end server 44.

Users can query back-end servers 44 through front-end server 42. An example of a user query might be a federated query that requires access to data from multiple back-end servers. As illustrated in exemplary system topology 40, there are three general steps involved when front-end 44 server executes a federated query. First, front-end server 44 parses the federated query into query fragments (or subqueries) such that each query fragment only accesses tables in one back-end server. Next, each query fragment is sent to its corresponding back-end server, and the partial results for each are returned to front-end server 44. Front-end server 44 then integrates the partial results to generate the final answer to the federated query. It follows that the total resource time for running a federated query can generally be divided into three components corresponding to these three processing steps, respectively. While the times corresponding to the first and third steps are invariant for a given federated query, the time for the second step could be different as different MQTs are placed on back-end servers 44, even for the same federated query.

For ease of reference, a function t can be provided by the following definition: Given a federated query q, the function t(q) denotes the resource time required by the front-end server to complete the return of the partial result for each query fragment sent from all of the back-end servers in the second step. Letting q^{[i]} correspond to the query fragment that is sent to back-end server i, t(q^{[i]}) then stands for the resource time required by the front-end server to complete the second step for back-end server i. It follows that t(q) is the maximum of t(q^{[i]}). In exemplary embodiments, the function t can be provided using a cost estimator and its result can depend on the MQT placement on back-end servers. In exemplary embodiments, the function t can additionally accept a set of MQTs as a second parameter. For example, letting v correspond to a set of MQTs, t(q; v) then corresponds to the resource time for federated query q when the MQTs in set v are placed at corresponding back-end servers.

In exemplary embodiments, a federated MQTA can be employed that takes into consideration the correlation among multiple back-end servers in a distributed system when it recommends MQTs for these multiple back-end servers. The federated MQTA can implement an algorithm that, given a workload with K federated queries and a space limit for each back-end server for storing MQTs, recommends MQTs for each back-end server such that the total resource time for running the workload is minimized. The times for parsing queries and integrating partial results at the front-end server are independent of the MQT placement at back-end servers. Thus, the goal of the algorithm can be stated as minimizing the total of t(qⁱ), for 1<=i<=K.

In exemplary embodiments, the FMQTA can consider the usage correlation among the back-end servers so as to recommend MQTs for the back-end servers that provide the maximum overall benefits for the federated queries. In exemplary embodiments, the FMQTA can implement a local search algorithm, such as a greedy hill climbing algorithm, that can be utilized to pick the best candidate MQTs for recommendation at each iterative step until no space is available at the back-end servers. During each iterative step, an MQT or a group of MQTs is selected that can provide the most return (that is, the greatest reduction in query time) on investment (that is, the required disk space to store these MQTs) to the federated workload.

In the present exemplary embodiment, to avoid overlooking the correlation between back-end servers, the FMQTA can also be implemented to consider groups of MQTs that come from multiple back-end servers but are used by the same federated query. In general principle, the algorithm considers any subset of the set of MQTs from all the back-end servers and used by the federated queries, and such a subset is referred to as an MQT group. As an example, for the query shown FIG. 3a, the MQT group from each individual back-end server or any two back-end servers have zero benefit. In contrast, the group of MQTs used by all the subqueries can have a positive benefit to the federated query that is close to time t if it is assumed that all expensive operations are materialized in these MQTs. Therefore, the group of MQTs from all the back-end servers should be recommended in this example. As another example, for the query shown in FIG. 2b, the group of MQTs from BE₃ have a positive benefit for the group of MQTs from BE₂ and BE₃ or from all the three back-end servers. In exemplary embodiments, return-on-investment values can be used to decide which MQT group to select, as will be described in greater detail.

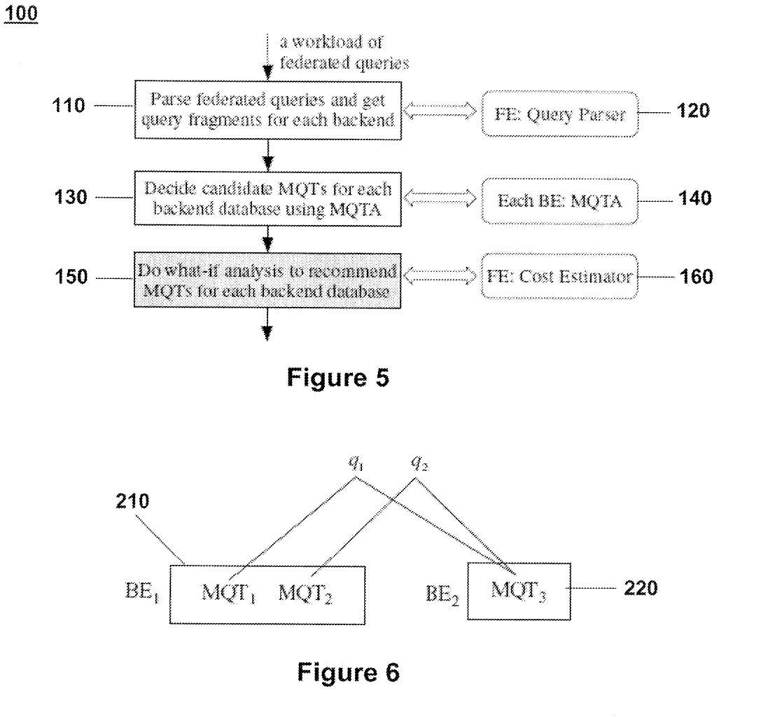

Turning now to FIG. 5, a system architecture and operational flow for an exemplary embodiment of an FMQTA 100 configured to execute a given federated query is provided. FMQTA 100 generally performs three main steps. At block 110, given a workload containing federated queries, FMQTA 100 compiles or parses these queries using a front-end query parser 120, and the query parser returns the lists of query fragments to be sent to the corresponding back-end servers. Then, at block 130, FMQTA 100 invokes the MQTA on each back-end server 140 with the corresponding list of query fragments, and the MQTA on each back-end server recommends a list of candidate MQTs along with useful information about MQTs that includes the estimated size and the synchronization cost of each MQT. In exemplary embodiments, FMQTA 100 can derive the MQT dependency information, such as how multiple MQTs are used together within a federated query, from the output. At block 150, FMQTA 100 invokes a front-end cost estimator 160 and performs a greedy what-if analysis to determine which MQTs to be placed at the back-end servers.

In exemplary embodiments, the what-if process performed at block 150 can involve two primary concepts: (1) a virtual caching unit (VCU), which is either a singleton candidate MQT or a set of candidate correlated MQTs that are used together by a federated query; and (2) return on investment (ROI) for each VCU. The ROI for a VCU is the net benefit of the VCU (that is, additional benefit minus additional overhead) for the workload when the MQTs in the VCU are placed on top of the already-placed MQTs. The investment is the total size of the MQTs in the VCU and their indexes, excluding the already-placed MQTs. The ROI of the VCU is the calculated net benefit divided by the calculated size.

A VCU is the primitive unit of consideration during the what-if analysis. The VCUs from each federated query are put together as the list of candidate VCUs for the what-if analysis. The resulting candidate VCUs are much fewer than those that would be generated by a native approach that inspects the benefits all the subsets of the set of candidate MQTs, in which the total number of candidate subsets is exponential to the number of candidate MQTs. The ROI provides a priority value for each VCU. A VCU with the highest ROI value is chosen over those with lower ROI values. The benefit of a VCU is measured as the resource time gain with respect to the front-end server of the federated query if that VCU is recommended.

As an example, FIG. 6 illustrates an exemplary set of federated queries q₁ and q₂ and the MQTs used by the federated queries at back-end servers 210, 212. For the VCU set {MQT₁; MQT₃}, its initial benefit for q₁ is t₁=t(q₁; Ø)−t(q₁; {MQT₁; MQT₃}). The benefit of the VCU for q₂ is t₂=t(q₂; Ø)−t(q₂; {MQT₁; MQT₃}). In this example, since q₂ does not use MQT₁, the estimated time t(q₂; {MQT₁; MQT₃}) is equal to t(q₂; {MQT₃}). The total benefit of the VCU is the summation of t₁ and t₂. The overhead of a VCU is the summation of the overhead values of the MQTs in the VCU, excluding already-placed MQTs. It can include factors such as the cost of refreshing an MQT and the cost of rebuilding indexes if present.

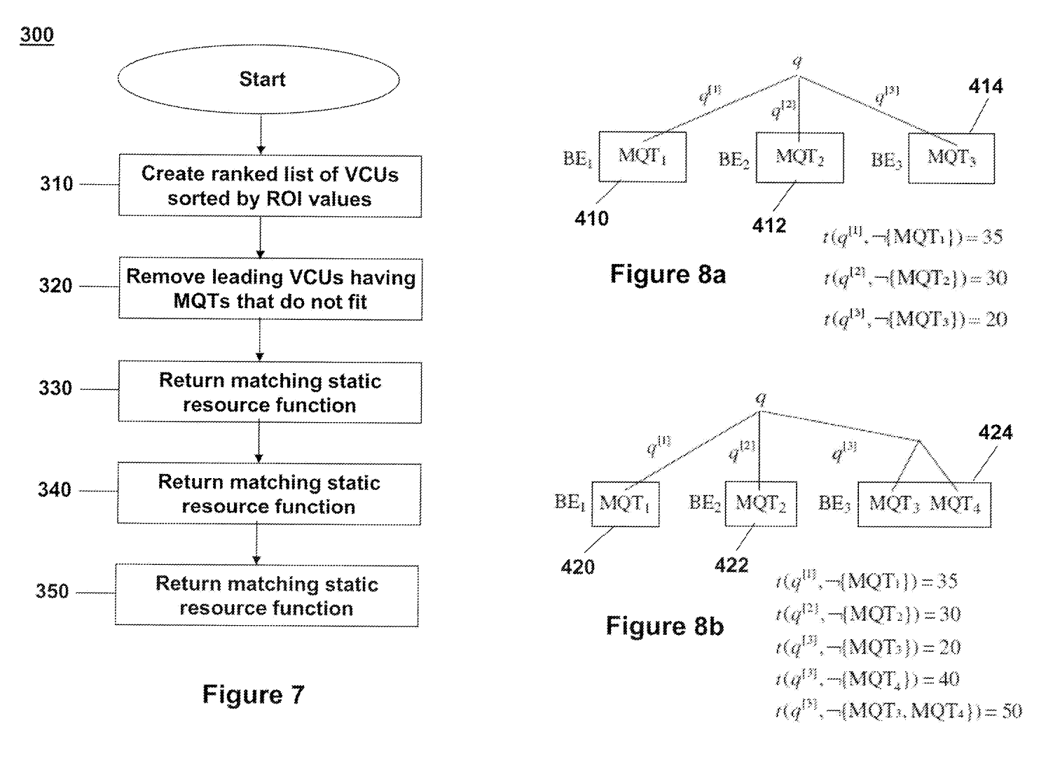

In exemplary embodiments, the what-if analysis performed by an FMQTA can involve a five-step process, as illustrated in the flow diagram provided in FIG. 7. At block 310 of process 300 shown in FIG. 7, a ranked list of the VCUs is created that is sorted by ROI values of the VCUs in descending order. At block 320, each of the leading VCUs having MQTs that do not fit in the back-end servers are removed due to space constraints. At block 330, the head VCU from the ranked list is removed, and the MQTs in the head VCU are added to the recommendation list. It should be noted that after some MQTs are selected into the recommendation list, the ROIs of the candidate VCUs become the additional ROIs on top of the recommendation list. For example, given a VCU v and a current recommendation list M, the benefit of v for a federated query q is t(q, v union M)−t(q, M). Similarly, the overhead and the size of v should not include those MQTs that are already included in M. At block 340, the ROIs for each of the VCUs remaining in the ranked list are recalculated by considering the possible impact of the selected MQTs to the candidate VCUs resulting from dependency on benefit, space, and overhead. At decision block 350, the process returns to block 310, unless no VCU can be selected, either because the space limit is reached or no VCU is available, in which case the process terminates at block 360.

In the present exemplary embodiment, the algorithmic complexity of process 300 and the number of calls to the cost estimator (through the function t) are both polynomial to the number of candidate VCUs and the number of federated queries. More particularly, the algorithmic complexity can be expressed as O(|W|*|V|²), where |W| represents the number of queries in the workload and |V| represents the number of candidate VCUs considered. All VCUs could be selected one after another through what-if process 300 illustrated in FIG. 7. Therefore, there could be |V| iterations performed in the entire what-if process. As a result, the algorithmic complexity and the number of calls to the cost estimator are both O(|W|*|V|²) in the worst case.

In exemplary embodiments in which the number of back-end servers is large and each federated query requires data from many back-end servers, the number of candidate VCUs from each federated query in the what-if process can be reduced so that the number of candidate VCUs can avoid being exponential to the number of MQTs used by the query. Rather, the number of candidate VCUs can be made linear to the number of MQTs used by the query so as to avoid evaluation of all possible combinations. To provide this scalability without losing any good solution in the search space, an FMQTA can be implemented that exploits the parallelism property of multi-back-end distributed systems to provide for a lossless solution. According to the parallelism property, subqueries with longer execution time can decide the final completion time of all the subqueries—that is, slower subqueries can dominate faster subqueries, and thus, the time to collect partial results from multiple back-end servers is dominated by the most costly back-end server. This ability to dominate can allow for the MQTs for the dominant subqueries to be favored over the MQTs for the dominated subqueries, and concurrently enable reduction of the number of candidate MQTs to be investigated during each step by not considering the subqueries for candidate MQTs that are dominated by the dominant subqueries.

The parallelism property can be defined as follows: Letting q be a federated query against N back-end servers, under function t, t(q^{[1]}), t(q^{[2]}), . . . , t(q^{[N]}) are the times needed for the front-end server to collect the partial results from the respective back-end servers. Then, the total time required by the front-end server to collect all the partial results (that is, t(q)) is equal to max(t(q^{[1]}), t(q^{[2]}), . . . , t(q^{[N]})). The intuition behind this definition is that, because the back-end servers run their corresponding query fragments in parallel, the front-end server only needs to wait as much time as required to collect the partial result from the slowest back-end server.

FIG. 8a illustrates an exemplary federated query that uses three MQTs from three back-end servers 410, 412, 414 respectively to illustrate how the parallelism property can be used by the FMQTA to spot spurious VCUs and remove them from consideration at the outset of the what-if analysis. In FIG. 8a, there is a negative symbol, −, in front of the MQT that is passed to the t function to indicate that it is referring to all candidate MQTs except for the one following −. For example, “t(q^{[1]}; −{MQT₁})=35” in FIG. 8a means that the query fragment q^{[1]} takes 35 time units if MQT₁ is not present. Because q^{[1]} only uses one MQT, MQT₁, t(q^{[1]}; {MQT₁}) is actually equal to t(q₁; Ø). In the present example, there are six subsets out of the set {MQT₁; MQT₂; MQT₃} Without loss of generality, the times for running the three query fragments (q^{[1]}, q^{[2]}, and q^{[3]}) without using the corresponding MQTs are assumed to be 35, 30, and 20, respectively. Based on these estimates, a conclusion that some VCUs need not be considered can be reached. For example, the VCU {MQT₂} is useless by itself because, although MQT₂ can reduce the time for q^{[2]}, it still takes the front-end server 35 time units to collect the result of q^{[1]} when MQT₁ is absent. Following the same analysis, a conclusion that only three VCUs need to be considered can be reached: {MQT₁}, {MQT₁; MQT₂}, and {MQT₁; MQT₂; MQT₃}.

In exemplary embodiments, the parallelism property can be applied with restriction to find candidate VCUs. For instance, under a one-MQT assumption, given a federated query q, it is assumed that each query fragment q^{[1]} uses at most one candidate MQT on back-end server i. In the following discussion of exemplary embodiments in which this restriction is applied, it is assumed that each federated query in consideration must access all the back-end servers in the system (that is, there is one query fragment for each back-end server). Of course, it should be noted that this assumption is non-limiting, and that such a restriction can also be applied to cases in which a federated query only accesses a subset of the back-end servers. In the example described above with reference to FIG. 8a, it was demonstrated that a subset (such as {MQT₂; MQT₃}) of the MQTs used by a federated query does not help reduce the resource time of running a federated query if a dominating MQT (MQT₁ in the example) is not present. The dominance relationship between MQTs can be defined as follows: By convention, in a federated query q against N back-end servers, the query fragment to back-end server i (for 1≦i≦N) is q^{[i]} and uses one MQT, MQT^{[i]}. It can be stated, then, that MQT^{[x]} dominates MQT^{[y]} if t(q^{[x]}; −{MQT^{[x]}})≧t(q^{[1]}; −{MQT^{[y]}}).

Therefore, by applying the parallelism property, the FMQTA becomes aware that, if a dominated MQT appears in some VCU v, the VCU must also contain the dominating MQT for it to have positive ROI value. It follows that a VCU that does not contain the dominating MQT does not have positive ROI value. This observation can be used in exemplary embodiments to implement the following algorithm for finding nontrivial VCUs using the parallelism property. First, the MQTs used by a federated query are sorted according to their dominance relationship (each MQT in the sorted list is dominated by all the preceding MQTs in the list). Then, for each MQT, MQTᵢ in the list, one candidate VCU is created that contains MQTᵢ and its dominating MQTs (that is, all the MQTs preceding MQTᵢ). The sorted list can be referred to as a dominance path. For instance, in the example described above with reference to FIG. 8a, the sorted list of the MQTs should be in the order of MQT₁, MQT₂ and MQT₃. The three candidate VCUs are exactly {MQT₁}, {MQT₁; MQT₂}, and {MQT₁; MQT₂; MQT₃}.

The algorithmic complexity of the what-if analysis using the parallelism property as described above remains the same as before: O(|W|*|V|²). The number of VCUs |V|, however, is greatly reduced. More particularly, applying the parallelism property, the number of candidate VCUs for each federated query, as well as the number of calls to the cost estimator, is linear to the number of MQTs accessed by the federated query.

In practical exemplary embodiments, multiple MQTs can be used by each query fragment. As an example, FIG. 8b illustrates an exemplary federated query q using four MQTs from three back-end servers 420, 422, 424 such that its query fragment q^{[3]} uses two MQTs on back-end server 424. In this example, good candidate VCUs could be lost if the approach of applying the parallelism property with restriction to find candidate VCUs under the one-MQT assumption is used. To illustrate, the first four function t values in FIG. 8b will provide the dominance path MQT₄→MQT₁→MQT₂→MQT₃ under the one-MQT assumption. According to this dominance path, only four candidate VCUs, not including {MQT₃; MQT₄}, can be found. It can be seen, however, that {MQT₃; MQT₄} is a valid candidate VCU because the time to perform the federated query can be decreased (from 50 to 35) by using it. Although MQT₄ is the dominating MQT, {MQT₃; MQT₄} should still be kept as a candidate MQT for evaluation since the ROI of a MQT could change over time after some MQTs are selected for placement.

A dominance relationship does not exist for MQTs on the same back-end server. Rather, MQTs used by the same query fragment can add up together to dominate MQTs on other back-end servers, although each individual MQT might not do so. For example, the fifth t value in FIG. 8b shows that when MQT₃ and MQT₄ are combined, they dominate both MQT₁ and MQT₂, but MQT₃ itself does not dominate either.

To ensure that all candidate VCUs are maintained, an FMQTA can be implemented in exemplary embodiments to consider all of the nonempty subsets of MQTs used by each query fragment by relaxing the one-MQT assumption. In FIG. 8b, for instance, because the query fragment q^{[3]} uses both MQT₃ and MQT₄, three (that is, 2²−1=3) nonempty subsets are provided: {MQT₃}, {MQT₄}, and {MQT₃, MQT₄}. Together with {MQT₁} and {MQT₂}, five MQT sets are provided. Sorting the five MQT sets according to their negative times as shown in FIG. 8b provides the following sorted list: {MQT₃, MQT₄}, {MQT₄}, {MQT₁}, {MQT₂}, {MQT₃}. Because a dominance relationship does not hold for MQTs on the same back-end server, multiple dominance paths can be created for the present example with separate branches for neighboring MQT sets from the same back-end server, as illustrated in FIG. 8c. With the dominance paths created in this fashion, VCUs for each dominance path can be found. Thus, the candidate VCUs created from the two dominance paths, with duplicates removed, are as follows: {MQT₃, MQT₄}, {MQT₃, MQT₄, MQT₁}, {MQT₃, MQT₄, MQT₁, MQT₂}, {MQT₄}, {MQT₄, MQT₁}, {MQT₄, MQT₁, MQT₂}. As shown by the preceding example, when the same query fragment uses multiple MQTs, the number of candidate VCUs is no longer linear. Rather, in the worst case when each federated query only has one query fragment and the query fragment uses multiple MQTs, the candidate VCUs are the same as those created by the FMQTA when not utilizing the parallelism property.

It should be noted that the foregoing examples are non-limiting, and that the principles described can be generalized for any number of multiple federated queries in exemplary embodiments.

In exemplary embodiments, materialized views can be maintained in data warehouses. In exemplary embodiments, these data warehouses can be implemented to perform incremental view maintenance and perform local refreshment of the MQTs recommended by FMQTAs on back-end servers. Exemplary embodiments can be implemented to analyze an entire workload and proactively cache MQTs for matching incoming queries rather than being triggered by incoming queries. In exemplary embodiments, a middleware software component such as, for example, DBPRoxy and TimesTen, can be incorporated to provide caching functionality for query results in the main memory at the front-end database. The query results can be cached and assigned with TTL (Time to Live) for exploration. Incoming queries can be compared with cached query results via containment checks in which if the incoming queries are contained by the cached query results, the queries are answered by the cached results. In exemplary embodiments, the cache replacement management can be based upon a LFU (Least Frequently Used) strategy, in which a count of how often item are needed is kept, and those that are used least often are discarded first.

Exemplary embodiments of the present invention can be implemented to match incoming queries by analyzing the entire workload and proactively cache MQTs. Exemplary embodiments can be implemented to support a data placement advisor to recommend what MQTs to place in the caches in the federation server or remote server. The FMQTA can be implemented to focus on the queries submitted to the remote servers regardless of whether there is a cache hit at the federation server. Exemplary embodiments can be implemented within a system in which the remote servers are heterogeneous database systems and could have their own MQT advisors. Exemplary embodiments can be implemented within a system in which the federation server may or may not be parallelism aware.

Exemplary embodiments can be implemented any suitable heterogeneous, distributed database management system such as, for example, a federated database system, as well as within database systems that are configured to perform parallel database processing and those configured to perform only serial database processing. Exemplary embodiments can be implemented as a middleware software component that can be deployed outside of the database systems and utilize MQT selection across multiple remote servers to achieve parallelism. Exemplary embodiments can be implemented to handle both federated query workload and local query workload on the remote servers in the federated query workload because these local queries will be routed to their original remote servers. Exemplary embodiments can be applied to shared-nothing parallel database systems in which data is horizontally partitioned among multiple independent nodes, as well to situations in which each node has different load, computation power, and/or disk space constraints. Exemplary embodiments can be implemented, for a given partition, to adjust load distribution via MQT selection to ensure better load balance and parallelism across multiple nodes for shared-nothing parallel database systems.

The capabilities of exemplary embodiments of present invention described above can be implemented in software, firmware, hardware, or some combination thereof, and may be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. Exemplary embodiments of the present invention can also be embedded in a computer program product, which comprises features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Therefore, one or more aspects of exemplary embodiments of the present invention can be included in an article of manufacture (for example, one or more computer program products) having, for instance, computer usable media. The media has embodied therein, for instance, computer readable program code means for providing and facilitating the capabilities of the present invention. The article of manufacture can be included as a part of a computer system or sold separately. Furthermore, at least one program storage device readable by a machine, tangibly embodying at least one program of instructions executable by the machine to perform the capabilities of the exemplary embodiments of the present invention described above can be provided.

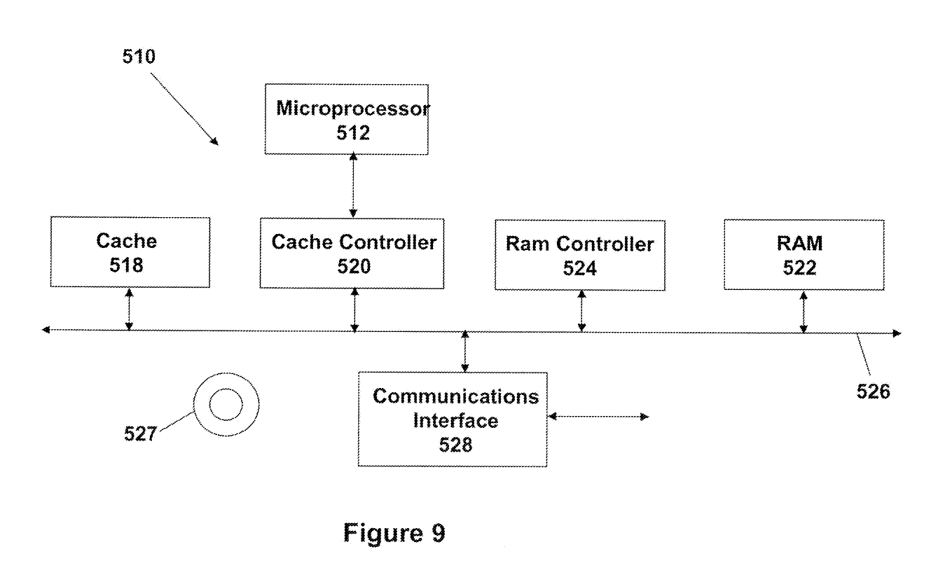

For instance, exemplary embodiments of the present invention can be implemented within the exemplary embodiment of a hardware configuration provided for a computer system in FIG. 9. FIG. 9 illustrates an exemplary computer system 510 upon which exemplary embodiments of the present invention can be implemented. A processor or CPU 512 receives data and instructions for operating upon from on-board cache memory or further cache memory 518, possibly through the mediation of a cache controller 520, which can in turn receives such data from system read/write memory (“RAM”) 522 through a RAM controller 524, or from various peripheral devices through a system bus 526. The data and instruction contents of RAM 522 will ordinarily have been loaded from peripheral devices such as a system disk 527. Alternative sources include communications interface 528, which can receive instructions and data from other computer systems.

The above-described program or modules implementing exemplary embodiments of the present invention can work on processor 512 and the like to perform shape interpolation. The program or modules implementing exemplary embodiments may be stored in an external storage medium. In addition to system disk 527, an optical recording medium such as a DVD and a PD, a magneto-optical recording medium such as a MD, a tape medium, a semiconductor memory such as an IC card, and the like may be used as the storage medium. Moreover, the program may be provided to computer system 510 through the network by using, as the recording medium, a storage device such as a hard disk or a RAM, which is provided in a server system connected to a dedicated communication network or the Internet.

Although exemplary embodiments of the present invention have been described in detail, it should be understood that various changes, substitutions and alternations can be made therein without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A method for generating a materialized view recommendation for at least one back-end server that is connected to a front-end server in a heterogeneous, distributed database system, the method comprising:
parsing a workload of federated queries received by the front-end server to generate a plurality of query fragments corresponding to the workload;
invoking a materialized view advisor on each of the at least one back-end server with the plurality of query fragments to generate a set of candidate materialized views for each of the plurality of query fragments;
identifying a first set of subsets corresponding to all nonempty subsets of the set of candidate materialized views for each of the plurality of query fragments;
identifying a second set of subsets corresponding to all subsets of the first set of subsets that are sorted according to a dominance relationship that is based upon a resource time for the at least one back-end server to provide results to the front-end server for each of the first set of subsets; and
performing a cost-benefit analysis of each of the second set of subsets to determine a recommended subset of materialized views that minimizes a total resource time for running the workload against the at least one back-end server.

2. The method of claim 1, wherein the workload of federated queries is parsed by a front-end query parser.

3. The method of claim 1, wherein the cost-benefit analysis of each of the second set of subsets is performed by a front-end cost estimator using a what-if analysis that is performed iteratively until a space constraint is reached or no subsets of the second set of subsets remains, the what-if analysis comprising:
creating a ranked list of subsets of the second set of subsets that is sorted according to a calculated value of the resource time for the at least one back-end server to provide results to the front-end server divided by an overhead cost for each subset in descending order;
removing each subset from ranked list of subsets that cannot fit in the at least one back-end server;
removing a head subset from the ranked list of subsets is removed and adding the materialized views of the head subset to a recommendation list; and
recalculating the calculated value for each subset remaining in the ranked list of subsets by considering the possible impact of the materialized views in the recommendation list.

4. The method of claim 1, wherein the set of candidate materialized views for each of the plurality of query fragments includes candidate materialized views that are generated by more than one back-end server of the at least one back-end server.

5. The method of claim 1, wherein the method is performed by a middleware software component deployed outside of the heterogeneous, distributed database system.
